(19) United States
(12) Patent Application Publication
(10) Pub. No.: US 2015/0035369 A1
(43) Pub. Date: Feb. 5, 2015

(54) CHARGING CONTROL CIRCUIT, METHOD AND ELECTRONIC DEVICE THEREOF

(71) Applicant: Fairchild Semiconductor Corporation, San Jose, CA (US)

(72) Inventors: Huoran HE, Shanghai (CN); Yongjin LUO, Shanghai (CN)

(73) Assignee: FAIRCHILD SEMICONDUCTOR CORPORATION, San Jose, CA (US)

(21) Appl. No.: 14/338,146

(22) Filed: Jul. 22, 2014

(30) Foreign Application Priority Data
Aug. 1, 2013 (CN) 201310335403.7

(51) Int. Cl. H02J 7/00; H02J 9/06

(52) U.S. Cl. CPC H02J 7/0068; H02J 9/061; H02J 2009/068
USPC 307/66

(57) ABSTRACT

The present invention discloses a charging control circuit, comprising an external power source, a switching circuit, and a charging path circuit comprising a first output circuit and a second output circuit, wherein the external power source is configured to charge a secondary battery through the first output circuit and charge a load through the second output circuit, and the switching circuit is configured to decouple the secondary battery from the load when the external power source is available. Meanwhile, the present invention discloses a charging control method and an electronic device; according to the present invention, because the two output circuits are coupled to the secondary battery and the load, respectively, the load will not divide up the charging current, thereby effectively shortening the charging time and prolonging the service life of the secondary battery.

### CROSS-REFERENCE TO RELATED APPLICATION

This application claims priority to and the benefit of Chinese Patent Application No. 201310335403.7, filed on Aug. 1, 2013, which is incorporated herein by reference in its entirety.

### TECHNICAL FIELD

The present invention relates to switching charger technologies, in particular, to a charging control circuit, and a method and an electronic device thereof.

### BACKGROUND ART

Portable devices are popular with users due to their advantages of being small and portable. For present portable devices, a secondary battery, such as a lithium battery, is often adopted to charge them. After the secondary battery discharges completely, a switching charger in the portable device is used to charge the secondary battery.

At present, a circuit of the switching charger usually has only one output terminal, and the output terminal is coupled to the secondary battery and an internal load of the portable device, such as a power management integrated circuit (PMIC). Therefore, during the charging process of the secondary battery, a current may pass through the load coupled to the output terminal of the circuit of the switching charger, and in this way the charging process of the secondary battery is prolonged, which may affect the working efficiency of the load.

For example, assuming that the load is a PMIC, a Low Dropout (LDO) voltage stabilizer of the PMIC usually works under a relatively low voltage, but when the secondary battery is being charged, it enables the working voltage of the LDO voltage stabilizer of the PMIC to rise due to the current passing through the PMIC. As a result, the working efficiency of the LDO voltage stabilizer is reduced.

### SUMMARY OF INVENTION

In order to solve the defects in the conventional art, the present invention provides a charging control circuit, a method and an electronic device thereof.

The technical solutions of the present invention are implemented as follows:

The present invention provides a charging control circuit, comprising: an external power source, a switching circuit, and a charging path circuit comprising a first output circuit and a second output circuit, wherein:
the external power source is configured to charge a secondary battery through the first output circuit, and charge a load through the second output circuit, and
the switching circuit is configured to decouple the secondary battery from the load when the external power source is available.

The present invention also provides a charging control method, comprising:
decoupling the secondary battery from the load when an external power source is available. At the same time, the external power source charges the secondary battery through a first output circuit of the charging path circuit, and charges the load through the second output circuit of the charging path circuit.

The present invention provides an electronic device, comprising a mainboard, a shell and a charging control circuit, wherein the charging control circuit comprises: an external power source, a switching circuit, and a charging path circuit comprising a first output circuit and a second output circuit.

The external power source is configured to charge the secondary battery through the first output circuit and to supply power to a load through the second output circuit.

The switching circuit is configured to decouple the secondary battery from the load when the external power source is available.

In the charging control circuit, method and electronic device provided in the present invention, when the external power source is available, the secondary battery and the load are decoupled; meanwhile, the external power source charges the secondary battery through the first output circuit of the charging path circuit, and supplies power to the load through the second output circuit of the charging path circuit. Because the two output circuits are coupled to the secondary battery and load, respectively, the load will not divide up the charging current during the process of charging the secondary battery, thus effectively shortening the charging time and prolonging the service life of the secondary battery.

In addition, because the two output circuits are coupled to the secondary battery and load, respectively, the load will not divide up the charging current during the process of charging the secondary battery, thus reducing the power consumption of the circuit and giving it better stability in high temperature environments.

Moreover, a DC voltage provided by the external power source or a converted DC voltage lower than the DC voltage provided by the external power source is converted by the second output circuit to a DC voltage matching that of the load for charging the load; therefore, the working efficiency of the load may be effectively guaranteed.

Additionally, in practical applications, an ultra low on-resistance metal-oxide-semiconductor (MOS) field-effect transistor is set between the secondary battery and the load as a switch in order to further reduce the circuit power consumption and further improve the circuit stability in high temperature environments.

### BRIEF DESCRIPTION OF THE DRAWINGS

FIG. 1 is a schematic structural diagram of a charging control circuit according to the present invention;

FIG. 2 is a schematic structural diagram of a charging path circuit according to the present invention;

FIG. 3 is a schematic structural diagram of a charging control circuit In practice according to the present invention;

FIG. 4 is a schematic flowchart of a first charging control method according to the present invention;

FIG. 5 is a schematic flowchart of a second charging control method according to the present invention;

FIG. 6 is a schematic flowchart of a third charging control method according to the present invention;

FIG. 7 is a schematic flowchart of a fourth charging control method according to the present invention; and

FIG. 8 is a schematic flowchart of a fifth charging control method according to the present invention.

### DETAILED DESCRIPTION OF PRESENT INVENTION

The basic inventive concept of the present invention is to decouple a secondary battery from a load when an external power source is available; at the same time, the external power source charges the secondary battery through a first output circuit of a charging path circuit and charges the load through a second output circuit of the charging path circuit.

The present invention is further detailed with reference to the attached drawings and specific embodiments.

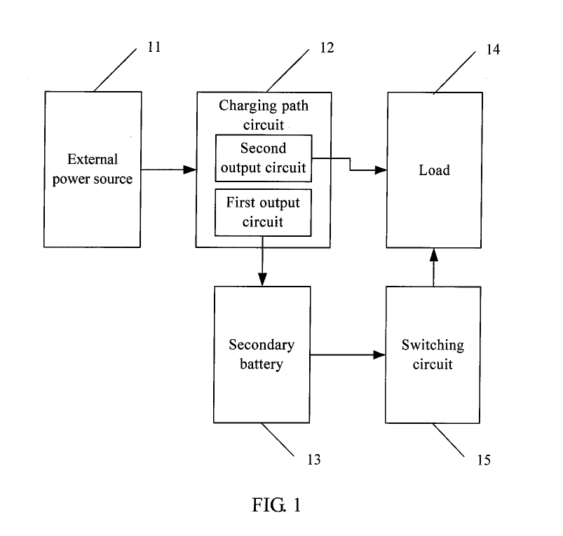

A charging control circuit of the present invention, as illustrated in FIG. 1, comprises: an external power source 11, a charging path circuit 12 comprising a first output circuit and a second output circuit, and a switching circuit 15.

When the external power source 11 is available, the switching circuit 12 decouples a secondary battery 13 from a load 14; at the same time, the external power source 11 charges the secondary battery 13 through the first output circuit and supplies power to the load 14 through the second output circuit.

The first output circuit converts a DC voltage provided by the external power source to a DC voltage matching the secondary battery, and outputs the converted DC voltage to the secondary battery to charge the secondary battery;

The second output circuit converts the DC voltage provided by the external power source to a DC voltage matching the load, and outputs the converted DC voltage to the load to supply power to the load.

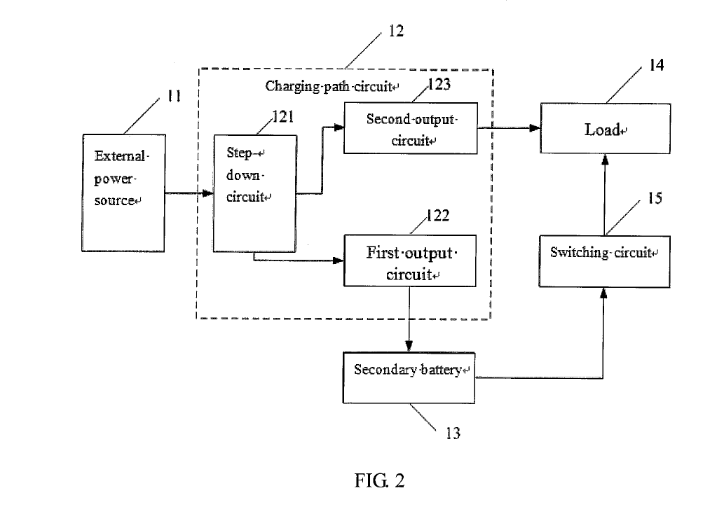

As illustrated in FIG. 2, the charging path circuit 12 may comprise a step-down circuit 121, a first output circuit 122, and a second output circuit 123.

The step-down circuit 121 converts the DC voltage provided by the external power source 11 to a DC voltage lower than the provided DC voltage.

The first output circuit 122 converts a DC voltage output by the step-down circuit 121 to a DC voltage matching the secondary battery 13, and outputs the converted DC voltage to the secondary battery 13 to charge the secondary battery 13.

The second output circuit 123 converts the DC voltage output by the step-down circuit 121 to a DC voltage matching the load 14, and outputs the converted DC voltage to the load 14 to supply power to the load.

A specific voltage value for the DC voltage lower than the provided DC voltage may be set here as needed.

Converting a DC voltage output by the step-down circuit 121 to a DC voltage matching the secondary battery 13 refers to converting the DC voltage output by the step-down circuit 121 to a DC voltage which is capable of directly charging the secondary battery 13. For example, assuming that the secondary battery 13 is a lithium battery, the charging voltage for lithium batteries is usually a 4.2 V DC voltage, then converting the DC voltage output by the step-down circuit 121 to a DC voltage which is capable of directly charging the secondary battery 13 refers to converting the DC voltage output by the step-down circuit 121 to a 4.2 V DC voltage in order to better charge the secondary battery 13.

The converting the DC voltage output by the step-down circuit 121 to a DC voltage matching the load 14 refers to converting the DC voltage output by the step-down circuit 121 to a DC voltage which may enable the load 14 to work more efficiently. For example, assuming that the load 14 is a power management integrated circuit (PMIC), and a Low Dropout (LDO) voltage stabilizer of PMICs works more efficiently when the working voltage is smaller, then converting the DC voltage output by the step-down circuit 121 to a DC voltage which may enable the load 14 to work more efficiently refers to converting the DC voltage output by the step-down circuit 121 to a lower DC voltage so as to enable the LDO voltage stabilizer of the PMIC to work more efficiently.

The secondary battery 13 may be a lithium battery or the like, and the load 14 may be a PMIC or the like.

When the external power source 11 is not available, the switching circuit 15 couples the secondary battery 13 to the load 14, and the secondary battery 13 supplies power to the load 14.

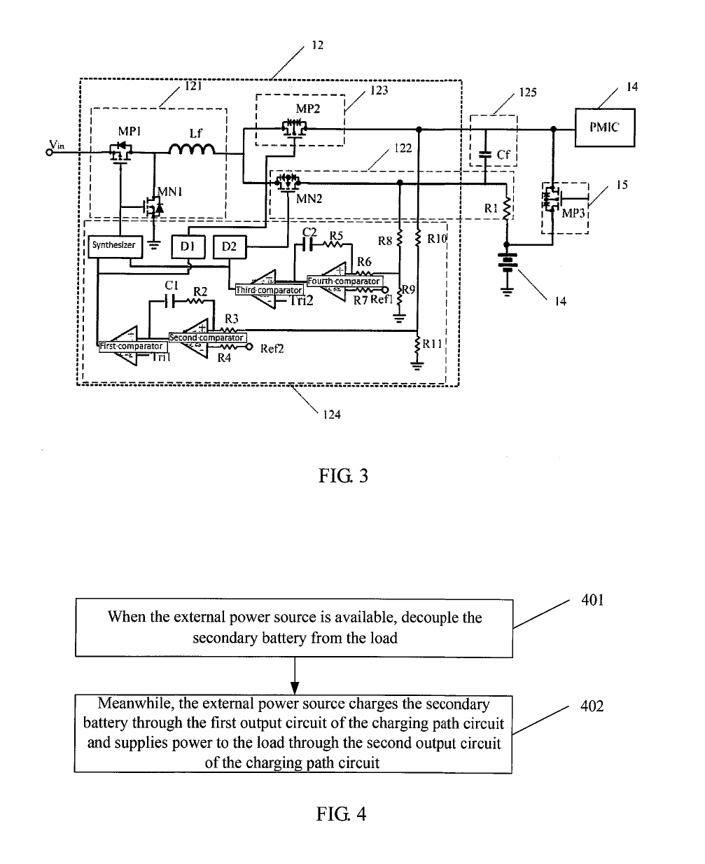

In practice, the charging control circuit provided in the present invention is as illustrated in FIG. 3, wherein the charging path circuit 12 may further comprise a charging path control circuit 124 and a filter circuit 125.

The charging control circuit 124 controls the step-down circuit 121, the first output circuit 122 and the second output circuit 123, enabling the external power source 11 to charge the secondary battery 12 through the step-down circuit 121 and the first output circuit 122, in turn, and enabling the external power source 11 to supply power to the load 14 through the step-down circuit 121 and the second output circuit 123, in turn.

When the external power source 11 is available, the filter circuit 125 filters the ripple from the first output circuit 122 and the second output circuit 123. Filtering the ripple from the first output circuit 122 and the second output circuit 123 refers to making the output DC voltage of the first output circuit 122 and the second output circuit 123 more smooth.

In practice, as illustrated in FIG. 3, the secondary battery 13 may be a lithium battery, and the load 14 may be a PMIC.

As illustrated in FIG. 3, the step-down circuit 121 may comprise a first positive-channel metal-oxide-semiconductor field-effect transistor (PMOS) MP1, a first negative-channel metal-oxide-semiconductor field-effect transistor (NMOS) MN1, and an inductor Lf; the first output circuit 122 may comprise a second NMOS MN2 and a first resistor R1; the second output circuit 123 may comprise a second PMOS MP2; the charging path control circuit 124 may comprise a synthesizer, a first comparator, a second comparator, a third comparator, a fourth comparator, a first driver D1, a second driver D2, a first capacitor C1, a second capacitor C2, a second resistor R2, a third resistor R3, a fourth resistor R4, a fifth resistor R5, a sixth resistor R6, a seventh resistor R7, an eighth resistor R8, a ninth resistor R9, a tenth resistor R10, and an eleventh resistor R11.

As illustrated in FIG. 3, the filter circuit 125 may comprise a third resistor Cf, and the switching circuit 15 may comprise a third PMOS MP3.

The coupling relationship among the components of the charging control circuit as illustrated in FIG. 3 is as follows:

In the step-down circuit 121, a gate of a first PMOS MP1 is coupled to an output terminal of the synthesizer of the charging path control circuit 124, and a source of the first PMOS MP1 is coupled to an output voltage Vin of the external power source 11; a drain of the first PMOS MP1 is coupled to one terminal of the inductor Lf and a drain of a first NMOS MN1; a gate of the first NMOS MN1 is coupled to an output terminal of the synthesizer of the charging path control circuit 124, and a source of the first NMOS MN1 is coupled to the ground; the other terminal of the inductor Lf is coupled to a source of the second NMOS MN2 of the first output circuit 122 and a source of the second PMOS MP2 of the second output circuit 123.

In the first output circuit 122, a gate of the second NMOS MN2 is coupled to an output terminal of the second driver D2 of the charging path control circuit 124, and a source and a drain of the second NMOS MN2 are coupled to a substrate; and the drain of the second NMOS MN2 is coupled to one terminal of the eighth resistor R8 of the charging path control circuit 124, one terminal of the first resistor R1, and one terminal of the third capacitor Cf of the filter circuit 125; the other terminal of the first resistor R1 is coupled to the secondary battery 13.

In the second output circuit 123, a gate of the second PMOS MP2 is connected to an output terminal of the first driver D1 of the charging path control circuit 124, and a source and a drain of the second PMOS MP2 are connected to a substrate; and the drain of the second PMOS MP2 is coupled to one terminal of the tenth resistor R10 of the charging path control circuit 124, the other terminal of the third capacitor Cf of the filter circuit 125, and the load 14.

In the charging path control circuit 124, a positive pole of the first comparator is coupled to an output terminal of the second comparator and one terminal of the first capacitor C1, and a negative pole of the first comparator is coupled to a first triangle-wave signal Tri1. An output terminal of the first comparator is coupled to an input terminal of the first driver D1 and an input terminal of the synthesizer, and the other terminal of the first capacitor C1 is coupled to one terminal of the second resistor R2. The other terminal of the second resistor R2 is coupled to a positive pole of the second comparator and one terminal of the third resistor R3, a negative pole of the second comparator is coupled to a second reference signal Ref2 through the fourth resistor R4, the other terminal of the third resistor R3 is coupled to one terminal of the tenth resistor R10, the other terminal of the tenth resistor R10 is coupled to one terminal of the eleventh resistor R11, and the other terminal of the eleventh resistor R11 is coupled to the ground. A positive pole of the third comparator is coupled to an output terminal of the fourth comparator and one terminal of the second capacitor C2, and a negative pole of the third comparator is coupled to a second triangle-wave signal Tri2. An output terminal of the third comparator is coupled to an input terminal of the second driver D2 and the other input terminal of the synthesizer, the other terminal of the second capacitor C2 is coupled to one terminal of the fifth resistor R5, the other terminal of the fifth resistor R5 is coupled to a positive pole of the fourth comparator and one terminal of the sixth resistor R6, a negative pole of the fourth comparator is coupled to a first reference signal Ref1 through the seventh resistor R7, the other terminal of the sixth resistor R6 is coupled to one terminal of the eighth resistor R8, the other terminal of the eighth resistor R8 is coupled to one terminal of the ninth resistor R9, and the other terminal of the ninth resistor R9 is coupled to the ground.

In the switching circuit 15, a gate of the third PMOS MP3 is coupled to a control signal, a source and a drain of the third PMOS MP3 are both coupled to a substrate, a source of the third PMOS is coupled to the load 14, and a drain of the third PMOS is coupled to the secondary battery 13.

The working principle of the charging control circuit as illustrated in the FIG. 3 is as follows:

When the external power source 11 is available, the control signal enables the third PMOS MP3 to decouple the secondary battery 13 from the load 14; meanwhile, the synthesizer synthesizes the logic levels of pulse width modulation (PWM) signals output by the first comparator and the third comparator to generate a driving voltage corresponding to either conducting or shutting down the first PMOS MP1 and the first NMOS MN1 so as to make the first PMOS MP1 and the first NMOS MN1 periodically conduct or shut down according to the PWM signal output by the synthesizer. At the same time, the first driver D1 converts the logic level of the PWM signal output by the first comparator to a driving voltage corresponding to either conducting or shutting down the second PMOS MP2 so as to make the second PMOS MP2 periodically conduct or shut down according to a PWM signal output by the first diver D1. The second diver D2 converts the logic level of the PWM signal output by the third comparator to a driving voltage corresponding to conducting or shutting down the second NMOS MN2 so as to make the second NMOS MN2 conduct or shut down periodically according a the PWM signal output by the second diver D2. Therefore, in the process of charging the secondary battery 13, the output voltage Vin of the external power source 11 is converted through the first PMOS MP1 and the inductor Lf to a DC voltage lower than the output voltage Vin of the external power source 11. In one aspect, a DC voltage output by the inductor Lf passes through the second NMOS MN2 and the first resistor R1, and is converted to a DC voltage that is capable of directly charging the secondary battery 13 so as to charge the secondary battery 13. In another aspect, the DC voltage output by the inductor Lf passes through the second PMOS MP2 and is converted to a DC voltage that may enable the load 14 to work more efficiently, thereby making the load 14 work properly and more efficiently.

When the external power source 11 is not available, the control signal enables the third PMOS MP3 to be coupled to the secondary battery 13 and the load 14, and then the secondary battery 13 charges the load 14; meanwhile, the source of the first PMOS MP1 is not coupled to the output voltage Vin of the external power source 11 so that the secondary battery 13 charges the load 14.

When the external power source 11 is not available, a ground level signal output by the synthesizer makes the first PMOS MP1 and the first NMOS MN1 shut down; meanwhile, a ground level signal output by the first driver D1 makes the second PMOS MP2 shut down, and a ground level signal output by the second driver D2 makes the second NMOS MN2 shut down to make the whole charging path circuit 12 stop working. The ground level signal refers to a level signal which is the same as the ground.

In the second PMOS MP2 and the third PMOS MP3, the source and the drain are coupled to the substrate to form a back-to-back diode. Correspondingly, in the second NMOS MN2, the source and the drain are coupled to the substrate to form a head-to-head diode. This coupling method is adopted in order to control the direction of the current. In other words, the current is only allowed to flow in a one-way direction to prevent a reverse current.

The third capacitor Cf forms a filter to filter the DC voltage passing through the second PMOS MP2 and the second NMOS MN2 to obtain a pure DC voltage.

The third PMOS MP3 is an ultra low on-resistance PMOS functioning as a switch. The ultra low on-resistance PMOS is adopted to reduce conductive power consumption so as to cut down the circuit power consumption. A value of the on-resistance of the ultra low on-resistance PMOS may be set as needed, such as 15 mΩ.

That the control signal enables the third PMOS MP3 to decouple the secondary battery 13 from the load 14 refers to no current flows from the secondary battery 13 through the third PMOS MP3 to the load 14.

When the synthesizer synthesizes the logic levels of the PWM signals output by the first comparator and the third comparator, if the PWM signal output by the first comparator is a high level signal, and the PWM signal output by the third comparator is a high level signal, then the synthesizer synthesizes the PWM signals output by the first comparator and the third comparator into high level PWM signals. If the PWM signal output by the first comparator is a low level signal, and the PWM signal output by the third comparator is a high level signal, then the synthesizer synthesizes the PWM signals output by the first comparator and the third comparator into low level PWM signals. If the PWM signal output by the first comparator is a high level signal, and the PWM signal output by the third comparator is a low level signal, then the synthesizer synthesizes the PWM signals output by the first comparator and the third comparator into low high level PWM signals. If the PWM signal output by the first comparator is a low level signal, and the PWM signal output by the third comparator is a low level signal, then the synthesizer synthesizes the PWM signals output by the first comparator and the third comparator into low level PWM signals in order to generate the driving voltage corresponding to conducting or shutting down the first PMOS MP1 and the first NMOS MN1.

At this point, it must be stated that when the external power source 11 is available and the secondary battery 13 is fully charged, the external power source 11 still supplies power to the load 14 through the first PMOS MP1, the inductor Lf, and the second PMOS MP2, in turn; in other words, as long as the external power source 11 is available, the control signal may make the third PMOS MP3 shut down so as to decouple the secondary battery 13 from the load 14, and then the external power source 11 supplies power to the load 14.

Based on the charging control circuit, the present invention further provides a charging control method. As illustrated in FIG. 4, the method comprises the following steps:

Step 401: When the external power source is available, decoupling the secondary battery from the load.

Step 402: At the same time, the external power source charges the secondary battery through the first output circuit of the charging path circuit and supplies power to the load through the second output circuit of the charging path circuit.

The specific implementation of the steps is as illustrated in step 402a of FIG. 5; the first output circuit converts a DC voltage provided by the external power source into a DC voltage matching the secondary battery to charge the secondary battery, and the second output circuit converts a DC voltage provided by the external power source into a DC voltage matching the load to supply power to the load.

In practice, step 401 and step 402 are performed concurrently.

Charging the secondary battery through the first output circuit of the charging path circuit by the external power source specifically comprises:
converting, through the first output circuit, the DC voltage provided by the external power source to the DC voltage matching the secondary battery in order to charge the secondary battery.

Correspondingly, supplying power to the load through the second output circuit of the charging path circuit comprises:
converting, through the second output circuit, a DC voltage provided by the external power source to a DC voltage matching the load to supply power to the load.

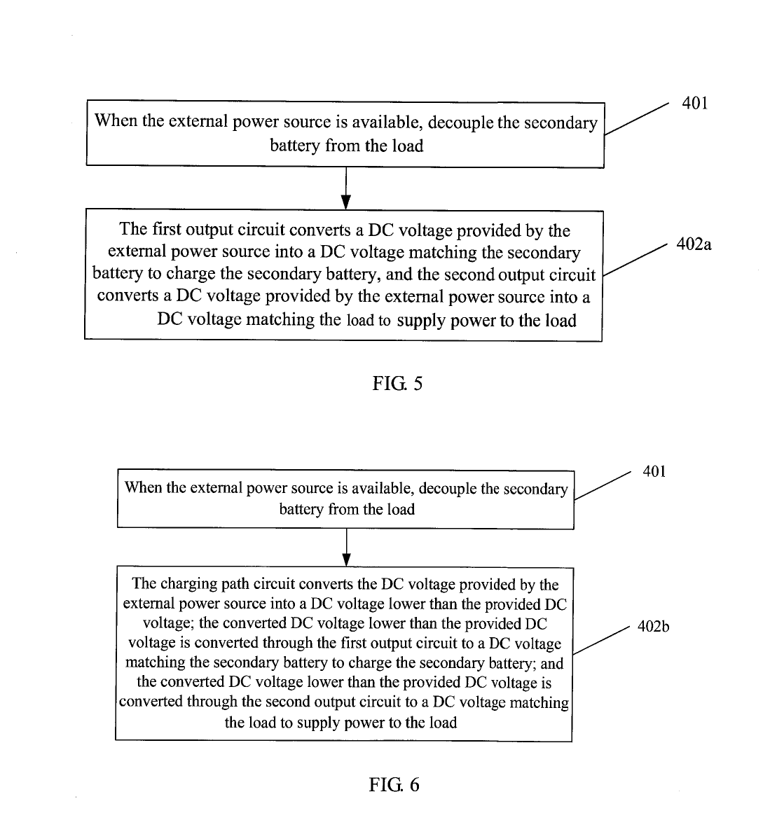

In practice, the specific implementation of these steps is as illustrated in step 402b of FIG. 6. The charging path circuit converts the DC voltage provided by the external power source into a DC voltage lower than the provided DC voltage; the converted DC voltage that is lower than the provided DC voltage is converted through the first output circuit to a DC voltage matching the secondary battery to charge the secondary battery; and the converted DC voltage lower than the provided DC voltage is converted through the second output circuit to a DC voltage matching the load to supply power to the load.

Specifically, charging the secondary battery through the first output circuit of the charging path circuit by the external power source comprises:
converting, by the charging path circuit, the DC voltage provided by the external power source to a DC voltage lower than the provided DC voltage; and
converting, through the first output circuit, the converted DC voltage lower than the provided DC voltage to a DC voltage matching the secondary battery to charge the secondary battery.

Correspondingly, supplying power to the load through a second output circuit of the charging path circuit comprises:
converting, through the second output circuit, converting the converted DC voltage that is lower than the provided DC voltage to a DC voltage matching the load to supply power to the load.

Converting the converted DC voltage that is lower than the provided DC voltage to a DC voltage matching the secondary battery refers to converting the converted DC voltage that is lower than the provided DC voltage to a DC voltage which is capable of directly charging the secondary battery. For example, assuming the secondary battery is a lithium battery, and that the charging voltage of lithium batteries is usually a 4.2 V DC voltage, then converting the converted DC voltage that is lower than the provided DC voltage to a DC voltage which is capable of directly charging the secondary battery refers to converting the converted DC voltage that is lower than the provided DC voltage to a 4.2 V DC voltage in order to better charge the secondary battery.

Converting the converted DC voltage that is lower than the provided DC voltage to a DC voltage matching the load refers to converting the converted DC voltage that is lower than the provided DC voltage to a DC voltage which may enable the load 14 to work more efficiently. For example, assuming that the load is a PMIC, and a LDO voltage stabilizer of the PMIC works more efficiently when the working voltage is smaller, then converting the converted DC voltage that is lower than the provided DC voltage to a DC voltage which may enable the load to work more efficiently refers to converting the converted DC voltage that is lower than the provided DC voltage to a lower DC voltage so as to enable the LDO voltage stabilizer of the PMIC to work more efficiently.

The secondary battery 13 may be a lithium battery or the like, and the load 14 may be a PMIC or the like.

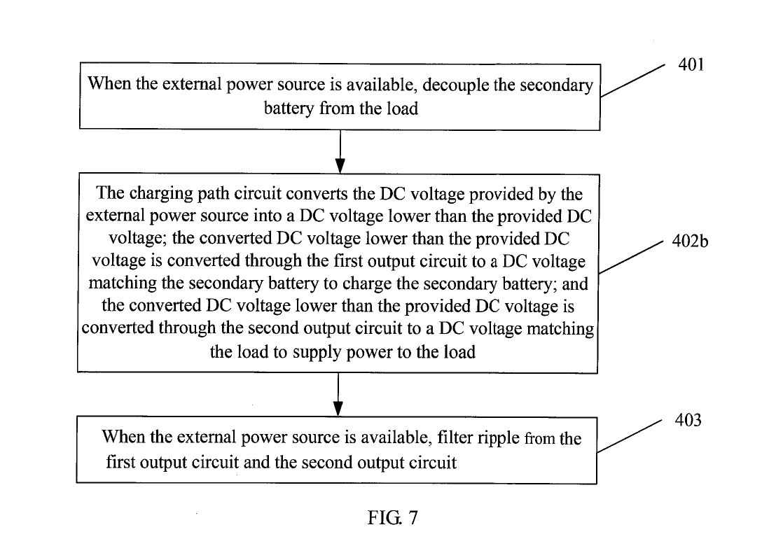

As illustrated in FIG. 7, the method may further comprise step 403: When the external power source is available, filtering the ripple from the first output circuit and the second output circuit. Filtering the ripple from the first output circuit and the second output circuit refers to making the output DC voltage of the first output circuit and the second output circuit more smooth. In practice, step 403 and step 402b are performed concurrently.

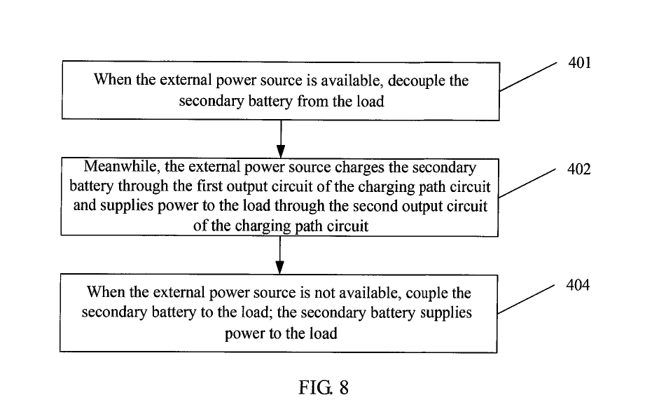

As illustrated in FIG. 8, the method may further comprise step 404: When the external power source is not available, coupling the secondary battery to the load; the secondary battery supplies power to the load.

Based on the charging control circuit, the present invention further provides an electronic device, comprising: a mainboard, a shell, and a charging control circuit. As illustrated in FIG. 1, the charging control circuit comprises an external power source 11, a charging path circuit 12 comprising a first output circuit and a second output circuit, and a switching circuit 15.

When the external power source 11 is available, the switching circuit 12 decouples a secondary battery 13 from a load 14; meanwhile, the external power source 11 charges the secondary battery 13 through the first output circuit and supplies power to the load 14 through the second output circuit.

The first output circuit converts a DC voltage provided by the external power source to a DC voltage matching the secondary battery, and outputs the converted DC voltage to the secondary battery to charge the secondary battery.

The second output circuit converts the DC voltage provided by the external power source to a DC voltage matching the load, and outputs the converted DC voltage to the load to supply power to the load.

As illustrated in FIG. 2, the charging path circuit 12 may comprise a step-down circuit 121, a first output circuit 122, and a second output circuit 123.

The step-down circuit 121 converts the DC voltage provided by the external power source 11 to a DC voltage lower than the provided DC voltage.

The first output circuit 122 converts a DC voltage output by the step-down circuit 121 to a DC voltage matching the secondary battery 13, and outputs the converted DC voltage to the secondary battery 13 to charge the secondary battery 13.

The second output circuit 123 converts the DC voltage output by the step-down circuit 121 to a DC voltage matching the load 14, and outputs the converted DC voltage to the load 14 to supply power to the load.

A specific voltage value for the DC voltage that is lower than the provided DC voltage may be set here as needed.

Converting the DC voltage output by the step-down circuit 121 to a DC voltage matching the secondary battery 13 refers to converting the DC voltage output by the step-down circuit 121 to a DC voltage that is capable of directly charging the secondary battery 13. For example, assuming that the secondary battery 13 is a lithium battery, and the charging voltage of the lithium battery is usually a 4.2 V DC voltage, then converting the DC voltage output by the step-down circuit 121 to a DC voltage which is capable of directly charging the secondary battery 13 refers to converting the DC voltage output by the step-down circuit 121 to a 4.2 V DC voltage in order to better charge the secondary battery 13.

The converting the DC voltage output by the step-down circuit 121 to a DC voltage matching the load 14 refers to converting the DC voltage output by the step-down circuit 121 to a DC voltage that may enable the load 14 to work more efficiently. For example, assuming that the load 14 is a PMIC, and an LDO voltage stabilizer of the PMIC works more efficiently when the working voltage is smaller, then converting the DC voltage output by the step-down circuit 121 to a DC voltage which may enable the load 14 to work more efficiently refers to converting the DC voltage output by the step-down circuit 121 to a lower DC voltage so as to enable the LDO voltage stabilizer of the PMIC to work more efficiently.

The secondary battery 13 may be a lithium battery or the like, and the load 14 may be a PMIC or the like.

When the external power source 11 is not available, the switching circuit 15 couples the secondary battery 13 to the load 14; the secondary battery 13 supplies power to the load 14.

In practice, the charging control circuit provided in the present invention is as illustrated in FIG. 3, wherein the charging path circuit 12 may further comprise a charging path control circuit 124 and a filter circuit 125.

The charging control circuit 124 controls the step-down circuit 121, the first output circuit 122 and the second output circuit 123 to enable the external power source 11 to charge the secondary battery 12 through the step-down circuit 121 and the first output circuit 122, in turn, and to enable the external power source 11 to supply power to the load 14 through the step-down circuit 121 and the second output circuit 123, in turn.

When the external power source 11 is available, the filter circuit 125 filters the ripple from the first output circuit 122 and the second output circuit 123. Filtering the ripple from the first output circuit 122 and the second output circuit 123 refers to making the output DC voltage from the first output circuit 122 and the second output circuit 123 more smooth.

In practice, as illustrated in FIG. 3, the secondary battery 13 may be a lithium battery; the load 14 may be a PMIC.

As illustrated in FIG. 3, the step-down circuit 121 may comprise a first PMOS MP1, a (NMOS) MN1, and an inductor Lf. The first output circuit 122 may comprise a second NMOS MN2 and a first resistor R1. The second output circuit 123 may comprise a second PMOS MP2. The charging path control circuit 124 may comprise a synthesizer, a first comparator, a second comparator, a third comparator, a fourth comparator, a first driver D1, a second driver D2, a first capacitor C1, a second capacitor C2, a second resistor R2, a third resistor R3, a fourth resistor R4, a fifth resistor R5, a sixth resistor R6, a seventh resistor R7, an eighth resistor R8, a ninth resistor R9, a tenth resistor R10, and an eleventh resistor R11.

As illustrated in FIG. 3, the filter circuit 125 may comprise a third resistor Cf, and the switching circuit 15 may comprise a third PMOS MP3.

The coupling relationship among components of the charging control circuit shown in FIG. 3 is as follows:

In the step-down circuit 121, a gate of a first PMOS MP1 is coupled to an output terminal of the synthesizer of the charging path control circuit 124, and a source of the first PMOS MP1 is coupled to an output voltage Vin of the external power source 11. A drain of the first PMOS MP1 is coupled to one terminal of the inductor Lf and a drain of a first NMOS MN1; a gate of the first NMOS MN1 is coupled to an output terminal of the synthesizer of the charging path control circuit 124, and a source of the first NMOS MN1 is coupled to the ground. The other terminal of the inductor Lf is coupled to a source of the second NMOS MN2 of the first output circuit 122 and a source of the second PMOS MP2 of the second output circuit 123.

In the first output circuit 122, a gate of the second NMOS MN2 is coupled to an output terminal of the second driver D2 of the charging path control circuit 124, and a source and a drain of the second NMOS MN2 are coupled to a substrate, and the drain of the second NMOS MN2 is coupled to one terminal of the eighth resistor R8 of the charging path control circuit 124, one terminal of the first resistor R1, and one terminal of the third capacitor Cf of the filter circuit 125; the other terminal of the first resistor R1 is coupled to the secondary battery 13.

In the second output circuit 123, a gate of the second PMOS MP2 is coupled to an output terminal of the first driver D1 of the charging path control circuit 124, and a source and a drain of the second PMOS MP2 are coupled to a substrate. The drain of the second PMOS MP2 is coupled to one terminal of the tenth resistor R10 of the charging path control circuit 124, the other terminal of the third capacitor Cf of the filter circuit 125, and the load 14.

In the charging path control circuit 124, a positive pole of the first comparator is coupled to an output terminal of the second comparator and one terminal of the first capacitor C1, and a negative pole of the first comparator is coupled to a first triangle-wave signal Tri1. An output terminal of the first comparator is coupled to an input terminal of the first driver D1 and an input terminal of the synthesizer, and the other terminal of the first capacitor C1 is coupled to one terminal of the second resistor R2. The other terminal of the second resistor R2 is coupled to a positive pole of the second comparator and one terminal of the third resistor R3, a negative pole of the second comparator is coupled to a second reference signal Ref2 through the fourth resistor R4, the other terminal of the third resistor R3 is coupled to one terminal of the tenth resistor R10, the other terminal of the tenth resistor R10 is coupled to one terminal of the eleventh resistor R11, and the other terminal of the eleventh resistor R11 is coupled to the ground. A positive pole of the third comparator is coupled to an output terminal of the fourth comparator and one terminal of the second capacitor C2, and a negative pole of the third comparator is coupled to a second triangle-wave signal Tri2. An output terminal of the third comparator is coupled to an input terminal of the second driver D2 and the other input terminal of the synthesizer, the other terminal of the second capacitor C2 is coupled to one terminal of the fifth resistor R5, the other terminal of the fifth resistor R5 is coupled to a positive pole of the fourth comparator and one terminal of the sixth resistor R6, a negative pole of the fourth comparator is coupled to a first reference signal Ref1 through the seventh resistor R7, the other terminal of the sixth resistor R6 is coupled to one terminal of the eighth resistor R8, the other terminal of the eighth resistor R8 is coupled to one terminal of the ninth resistor R9, and the other terminal of the ninth resistor R9 is coupled to the ground.

In the switching circuit 15, a gate of the third PMOS MP3 is coupled to a control signal, a source and a drain of the third PMOS MP3 are both coupled to a substrate, a source of the third PMOS is coupled to the load 14, and a drain of the third PMOS is coupled to the secondary battery 13.

The working principle of the charging control circuit as illustrated in the FIG. 3 is as follows:

When the external power source 11 is available, the control signal enables the third PMOS MP3 to decouple the secondary battery 13 from the load 14. At the same time, the synthesizer synthesizes the logic level of the PWM signal output by the first comparator and the third comparator to generate a driving voltage corresponding to either conducting or shutting down the first PMOS MP1 and the first NMOS MN1, in order to make the first PMOS MP1 and the first NMOS MN1 periodically conduct or shut down according to the PWM signals output by the synthesizer. At the same time, the first driver D1 converts the logic level of the PWM signals output by the first comparator to a driving voltage corresponding to conducting or shutting down the second PMOS MP2 in order as to make the second PMOS MP2 periodically either conduct or shut down according to a PWM signal output by the first driver D1. The second driver D2 converts the logic level of the PWM signal output by the third comparator to a driving voltage corresponding to either conducting or shutting down the second NMOS MN2, in order to make the second NMOS MN2 periodically either conduct or shut down according a the PWM signal output by the second diver D2. Therefore, in the process of charging the secondary battery 13, the output voltage Vin of the external power source 11 is converted through the first PMOS MP1 and the inductor Lf to a DC voltage that is lower than the output voltage Vin of the external power source 11. In one aspect, a DC voltage output by the inductor Lf passes through the second NMOS MN2 and the first resistor R1, and is converted to a DC voltage which is capable of directly charging the secondary battery 13 in order to charge the secondary battery 13; in another aspect, the DC voltage output by the inductor Lf passes through the second PMOS MP2 and is converted to a DC voltage which may enable the load 14 to work more efficiently, thereby making the load 14 work properly and more efficiently.

When the external power source 11 is not available, the control signal enables the third PMOS MP3 to be coupled to the secondary battery 13 and the load 14, and then the secondary battery 13 supplies power to the load 14. At the same time, the source of the first PMOS MP1 is not coupled to the output voltage Vin of the external power source 11 so that the secondary battery 13 charges the load 14.

When the external power source 11 is not available, a ground level signal output by the synthesizer makes the first PMOS MP1 and the first NMOS MN1 shut down. At the same time, a ground level signal output by the first driver D1 makes the second PMOS MP2 shut down, and a ground level signal output by the second driver D2 makes the second NMOS MN2 shut down to cause the whole charging path circuit 12 to stop functioning. The level signal refers to a level signal that is the same as the ground.

In the second PMOS MP2 and the third PMOS MP3, the source and the drain are coupled to the substrate to form a back-to-back diode. Correspondingly, in the second NMOS MN2, the source and the drain are coupled to the substrate to form a head-to-head diode. This coupling way is adopted to control the direction of the current. In other words, the current is only allowed to flow in a one-way direction to prevent a reverse current.

The third capacitor Cf forms a filter to filter the DC voltage passing through the second PMOS MP2 and the second NMOS MN2 to obtain a pure DC voltage.

The third PMOS MP3 is a PMOS of ultra small on resistance, functioning as a switch. The PMOS of ultra small on resistance is adopted to reduce conductive power consumption so as to cut down the circuit power consumption. A value of the on resistance of the PMOS of ultra small on resistance may be set as needed, such as 15 mΩ.

That the control signal enables the third PMOS MP3 to decouple the secondary battery 13 from the load 14 refers to no current flowing from the secondary battery 13 through the third PMOS MP3 to the load 14.

When the synthesizer synthesizes the logic levels of the PWM signals output by the first comparator and the third comparator, if the PWM signal output by the first comparator is a high level signal, and the PWM signal output by the third comparator is a high level signal, then the synthesizer synthesizes the PWM signals output by the first comparator and the third comparator into high level PWM signals. If the PWM signal output by the first comparator is a low level signal, and the PWM signal output by the third comparator is a high level signal, then the synthesizer synthesizes the PWM signals output by the first comparator and the third comparator into low level PWM signals. If the PWM signal output by the first comparator is a high level signal, and the PWM signal output by the third comparator is a low level signal, then the synthesizer synthesizes the PWM signals output by the first comparator and the third comparator into low high level PWM signals. If the PWM signal output by the first comparator is a low level signal, and the PWM signal output by the third comparator is a low level signal, then the synthesizer synthesizes the PWM signals output by the first comparator and the third comparator into low level PWM signals in order to generate the driving voltage corresponding to conducting or shutting down the first PMOS MP1 and the first NMOS MN1.

At this point, it must be stated that when the external power source 11 is available and the secondary battery 13 is fully charged, the external power source 11 still supplies power to the load 14 through the first PMOS MP1, the inductor Lf, and the second PMOS MP2, in turn; in other words, as long as the external power source 11 is available, the control signal may make the third PMOS MP3 shut down so as to decouple the secondary battery 13 from the load 14, and then the external power source 11 supplies power to the load 14.

The electronic device may be a mobile phone, an iPad, a laptop, or the like.

The above embodiments are merely preferred embodiments of the present invention, and are not intended to limit the protection scope of the present invention.

What is claimed is:

1. A charging control circuit, comprising:
an external power source, a switch circuit, and a charging path circuit comprising a first output circuit and a second output circuit; wherein:
the external power source is configured to charge a secondary battery through the first output circuit and supply power to a load through the second output circuit; and
the switch circuit is configured to decouple the secondary battery from the load when the external power source is available.

2. The circuit according to claim 1, wherein the first output circuit is configured to convert a DC voltage provided by the external power source to a DC voltage adaptive for charging the secondary battery, and to output the converted DC voltage to the secondary battery to charge the secondary battery; and
the second output circuit is configured to convert the DC voltage provided by the external power source to a DC voltage adaptive for powering the load, and to output the converted DC voltage to the load to supply power to the load.

3. The circuit according to claim 1, wherein the charging path circuit further comprises a buck circuit;
wherein the buck circuit is configured to convert the DC voltage provided by the external power source to a DC voltage lower than the provided DC voltage;
correspondingly, the first output circuit is configured to convert a DC voltage output by the buck circuit to a DC voltage adaptive for charging the secondary battery, and to output the converted DC voltage to the secondary battery to charge the secondary battery; and
the second output circuit is configured to convert the DC voltage output by the buck circuit to a DC voltage adaptive for powering the load, and to output the converted DC voltage to the load to supply power to the load.

4. The circuit according to claim 3, wherein the charging path circuit further comprises a charging path control circuit, configured to control the buck circuit, the first output circuit and the second output circuit to enable the external power source to charge the secondary battery through the buck circuit and the first output circuit, and enable the external power source to supply power to the load through the buck circuit and the second output circuit.

5. The circuit according to claim 3, wherein the charging path further comprises: a filter circuit, configured to filter out ripples from output voltages of the first output circuit and the second output circuit.

6. The circuit according to claim 1, wherein the switch circuit is further configured to couple the secondary battery to the load when the external power source is not available; and
the secondary battery is configured to supply power to the load.

7. The circuit according to claim 1, wherein the secondary battery is a lithium battery.

8. The circuit according to claim 1, wherein the load is a power management integrated circuit (PMIC).

9. A charging control method, comprising:
when an external power source is available,
decoupling a secondary battery from a load;
charging, by the external power source, the secondary battery through a first output circuit of a charging path circuit; and
supplying power, by the external power source, to the load through a second output circuit of the charging path circuit.

10. The method according to claim 9, wherein the charging comprises:
converting a DC voltage provided by the external power source to a DC voltage adaptive for charging the secondary battery through the first output circuit to charge the secondary battery; and
correspondingly, the supplying comprises:
converting a DC voltage provided by the external power source to a DC voltage adaptive for powering the load through the second output circuit to supply power to the load.

11. The method according to claim 9, wherein the charging comprises:
converting, by the charging path circuit, the DC voltage provided by the external power source to a DC voltage lower than the provided DC voltage; and
converting the converted DC voltage that is lower than the provided DC voltage to a DC voltage adaptive for charging the secondary battery through the first output circuit to charge the secondary battery;
correspondingly, the supplying comprises:
converting the converted DC voltage that is lower than the provided DC voltage to a DC voltage adaptive for powering the load through the second output circuit to supply power to the load.

12. The method according to claim 11, further comprising:
filtering out ripples from the output voltages of the first output circuit and the second output circuit.

13. The method according to claim 9, further comprising:
when the external power source is not available,
coupling the secondary battery to the load, and
supplying power to the load by the secondary battery.

14. An electronic device, comprising a mainboard, a shell and a charging control circuit, wherein the charging control circuit comprises an external power source, a switch circuit, and a charging path circuit comprising a first output circuit and a second output circuit; wherein:
the external power source is configured to charge a secondary battery through the first output circuit, and to supply power to a load through the second output circuit; and
the switch circuit is configured to decouple the secondary battery from the load when the external power source is available.

15. The circuit according to claim 14, wherein the first output circuit is configured to convert a DC voltage provided by the external power source to a DC voltage adaptive for charging the secondary battery, and to output the converted DC voltage to the secondary battery to charge the secondary battery; and
the second output circuit is configured to convert the DC voltage provided by the external power source to a DC voltage adaptive for powering the load, and to output the converted DC voltage to the load to supply power to the load.

16. The circuit according to claim 14, wherein the charging path circuit further comprises a buck circuit;
wherein the buck circuit is configured to convert the DC voltage provided by the external power source to a DC voltage lower than the provided DC voltage;
correspondingly, the first output circuit is configured to convert a DC voltage output by the buck circuit to a DC voltage adaptive for charging the secondary battery, and output the converted DC voltage to the secondary battery to charge the secondary battery; and
the second output circuit is configured to convert the DC voltage output by the buck circuit to a DC voltage adaptive for powering the load, and output the converted DC voltage to the load to supply power to the load.

17. The circuit according to claim 16, wherein the charging path circuit further comprises a charging path control circuit, configured to control the buck circuit, the first output circuit and the second output circuit to enable the external power source to charge the secondary battery through the buck circuit and the first output circuit, in turn, and enable the external power source to supply power to the load through the buck circuit and the second output circuit, in turn.

18. The electronic device according to claim 16, wherein the charging path further comprises: a filter circuit, configured to filter out ripples from the output voltages of the first output circuit and the second output circuit.

19. The circuit according to claim 14, wherein the switch circuit is further configured to couple the secondary battery to the load when the external power source is not available;
the secondary battery is configured to supply power to the load.

20. The electronic device according to claim 14, wherein the secondary battery is a lithium battery.

21. The electronic device according to claim 14, wherein the load is a power management integrated circuit (PMIC).
